(19) United States
(12) Patent Application Publication
(10) Pub. No.: US 2002/0033546 A1
(43) Pub. Date: Mar. 21, 2002

(54) Method and apparatus for forming a coating on optical fiber

(76) Inventors: Hidekazu Kojima, Tokyo (JP); Toshio Shibata, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/886,411

(22) Filed: Jun. 20, 2001

(30) Foreign Application Priority Data
Jun. 22, 2000 (JP) 2000-187251
May 16, 2001 (JP) 2001-145821

(51) Int. Cl. B05D 5/06; B05D 3/02; B29D 11/00; B29C 35/10

(52) U.S. Cl. 264/1.27; 427/163.2; 427/487; 427/385.5; 264/1.36; 264/1.38; 425/122; 425/144; 425/174.4

(57) ABSTRACT

A method of forming a coating and an apparatus for forming a coating on an optical fiber capable of improving the work speed in recoating a coating forming portion of the optical fiber are provided. A coating removed part of a coated optical fiber, which is the portion where a coating of the optical fiber is formed, is set in a mold. A light-curing resin is provided on the coating removed part. Then, with the light-curing resin heated to the glass transition temperature thereof by a Peltier element, a heater and a temperature control unit, a light for curing is irradiates from a light source to cure the light-curing resin.

### FIELD OF THE INVENTION

The present invention relates to method and apparatus for forming a coating on optical fiber in which the coating once removed for connecting a coated optical fiber is newly reproduced on a coated optical fiber connecting part for forming a coating thereon.

### BACKGROUND OF THE INVENTION

Traditionally, when coated optical fibers are to be connected, the coating that covers the circumference of the optical fibers has been removed at a coated optical fiber terminal and then the optical fibers have been connected each other. Subsequently, an optical fiber connecting part has been sandwiched by a reinforcing material or the connecting part has been coated with a heat-shrinkable tubing for protecting the connecting part.

Recently, in optical devices such as an optical fiber amplifier or an optical router, high packaging density has been demanded increasingly. With this, the number of connections of the coated optical fiber to be used has been increased and the downsized outside shape of the connecting part of the coated optical fiber has been desired. Then, in order to downsize the outside shape of the connecting part of the coated optical fiber, attention is being given to a structure in which a coating is newly reproduced on the connecting part of the optical fiber where the coating has been removed, for protecting the connecting part.

### SUMMARY OF THE INVENTION

The invention is to provide a method of forming a coating on an optical fiber in which a coating is reproduced on the connecting part of the optical fiber where a coating is removed, and an apparatus for forming a coating on the optical fiber.

One aspect of the method of forming a coating on the optical fiber in the invention comprises the steps of:

providing a light-curing resin on a coating forming portion of an optical fiber; and

irradiating with a light for curing the light-curing resin which has been heated up to a glass transition temperature of the resin or other heat setting temperatures.

Additionally, another aspect of the apparatus for forming a coating on the optical fiber in the invention comprises:

a mold for coating with a light-curing resin a portion on which a coating is to be formed of an optical fiber;

a heating-and-cooling unit for selectively heating and cooling the light-curing resin inside the mold;

a temperature sensor for detecting the temperature of the light-curing resin;

a light source for irradiating the light-curing resin with a light for curing; and

a temperature control unit for controlling the heating-and-cooling unit by a temperature detecting output of the temperature sensor to control temperatures of the light-curing resin,

wherein the temperature control unit heat-controls the light-curing resin to the glass transition temperature or other heat setting temperatures when irradiating the light-curing resin with the light for curing and cool-controls the light-curing resin after stopping light irradiating.

### BRIEF DESCRIPTION OF THE DRAWINGS

Exemplary embodiments of the invention will now be described in conjunction with drawings in which:

FIG. 1 depicts an illustration of one embodiment of the apparatus for forming a coating on the optical fiber in the invention;

FIG. 2 depicts a diagram illustrating the time variation in mold temperatures in one embodiment of method of forming a coating on the optical fiber in the invention;

FIG. 3 depicts an oblique perspective diagram of the other embodiment of the heating-and-cooling unit in the coating forming apparatus for the optical fiber in the invention;

FIG. 4 depicts an oblique perspective diagram of the other embodiment of the coating forming apparatus for the optical fiber in the invention;

FIG. 5 depicts an illustration of a control system of the embodiment shown in FIG. 4;

FIG. 6 depicts a diagram illustrating an operating procedure of the embodiment shown in FIG. 4; and

FIG. 7 depicts an illustration of an orthodox coating forming apparatus for the optical fiber.

### DETAILED DESCRIPTION

In order to newly reproduce a coating on the connecting part of the optical fiber where the coating has been removed, for example, there is a method in which a coating-removed part of a coated optical fiber is covered with a light-curing resin capable of being cured with ultraviolet light (a UV resin) and the ultraviolet light is irradiated from an ultraviolet light source to cure the UV resin.

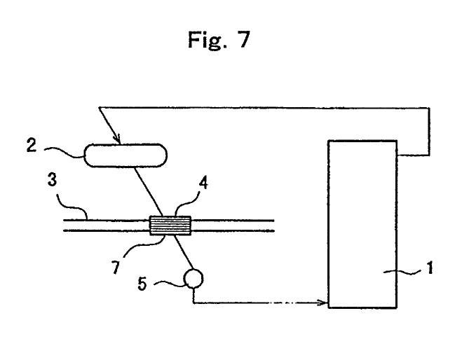

As shown in FIG. 7, for example, an orthodox apparatus for performing this method (a recoater) comprises a light source 2 for irradiating with ultraviolet light a UV resin 7 covering a coating-removed part 4 of a coated optical fiber 3, a photodetector 5 (a photodiode, for example) for receiving the light from the light source 2 to detect the intensity thereof and a light output controller 1. The light output controller 1 controls the light output of the light source 2 based on the ultraviolet light intensity that has been detected by the photodetector 5. This recoater irradiates the UV resin 7 covering the coating-removed part 4 with the ultraviolet light from the light source 2 to cure the UV resin 7. At this time, the recoater controls the light output of the light source 2 based on the ultraviolet light intensity that has been detected by the photodetector 5. According to this control, stable curing characteristics of the UV resin 7 can be obtained by the light output suitable for the curing conditions of the UV resin 7.

Recently, the speed of the fusion splicing work for the optical fiber has been improved. With this, high-speed recoating work is demanded in recoating the optical fiber connecting part.

To this end, when the connecting part is coated with the UV resin, the temperatures of the UV resin is set to slightly higher than ordinary temperatures for excellent flowability. In addition, the inventor has proposed a recoater in Japanese Patent Application (Japanese Patent Application No. 104758/2000) in which an environment sensor for detecting environmental information such as temperatures, humidities, atmospheric pressures and dew condensations is disposed in the area where the light source 2 and the photodetector 5 of the recoater, the light output of the light source 2 is controlled more accurately according to the environmental information that has been detected by the environment sensor and thereby further stable curing characteristics of the UV resin can be obtained.

However, the curing rate of the UV resin is determined by the characteristics of the UV resin. The extent to which the temperatures of the UV resin are set slightly higher than ordinary temperatures does not increase the curing rate of the UV resin sufficiently.

In addition, when the UV resin is filled in the mold to coat the optical fiber connecting part with the UV resin, the viscosity of the UV resin varies due to the change in ambient temperature. Thus, the manner in which the UV resin flows into the mold is changed, the UV resin is not sufficiently filled therein and consequently bubbles happen to occur.

In one aspect, the invention is to provide the method of forming a coating on the optical fiber capable of improving the work speed in recoating the optical fiber and the coating forming apparatus for use in the same method.

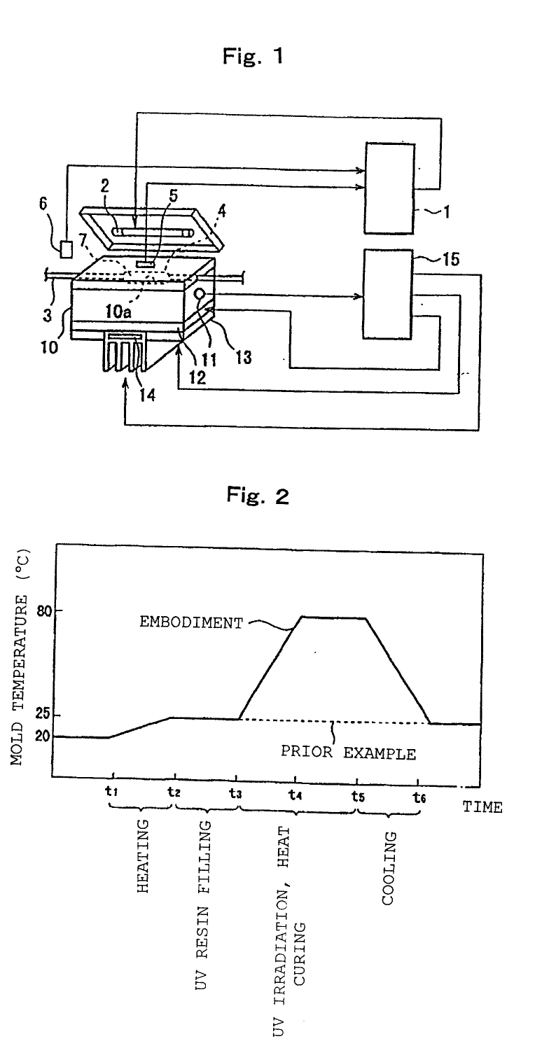

FIG. 1 depicts the illustration of one embodiment of the apparatus for forming the coating on the optical fiber in the invention.

In FIG. 1, the same portions as the portions that have been described in FIG. 7 are indicated by the same signs and numerals. In FIG. 1, a numeral 10 denotes a mold. A temperature sensor 11 is inserted into the mold 10 for detecting temperatures of a groove part 10a into which a light-curing resin is injected. A numeral 12 denotes a Peltier element mounted on the mold 10. A numeral 13 denotes a heater. A numeral 14 denotes a cooling fan with small fins.

Temperature information of the mold 10 that has been detected by the temperature sensor 11 is inputted to a temperature controller 15. The temperature controller 15 controls the Peltier element 12, the heater 13 and the fan 14 for controlling the temperatures of the mold 10 based on information from the temperature sensor 11.

Additionally, a numeral 6 denotes an environment sensor comprising the temperature sensor, a humidity sensor, an atmospheric pressure sensor and a dew concentration sensor. The environment sensor 6 detects environmental information in the area where the light source 2 or the photodetector 5 is disposed and the environmental information is inputted to a light output controller 1. The light output controller 1 controls the light output of the light-curing light source 2 based on the environmental information and the information from the photodetector 5 that detects the light intensity from the light source 2.

In one embodiment of the invention, the mold 10a is provided with a heating-and-cooling unit comprising the Peltier element 12, the heater 13, and the fan 14. Then, the temperatures of the mold 10 can be controlled in which the mold is heated and held at near the glass transition temperature of the light-curing resin (the UV resin in this case) and is cooled from the temperature.

According to the studies of the inventor through experiments, when the light for curing irradiates the light-curing resin which has been heated to the heat setting temperature, the glass transition temperature, for example, the curing rate of the light-curing resin can be increased as compared with the case in which the light for curing irradiates a light-curing resin having ordinary temperatures. Therefore, by using light irradiation curing and heat setting at the same time, the work speed in recoating the coating formed portion of the optical fiber can be more improved as compared to related art.

Furthermore, when the Peltier element is used in the heating-and-cooling unit for the light-curing resin, the Peltier element can switch the exothermic and endothermic functions promptly according to the current direction. Thus, it can shorten the time required to heat the light-curing resin inside the mold to the glass transition temperature and the time required to cool it from the glass transition temperature. Therefore, use of the Peltier element 12 as the heating-and-cooling unit can switch heating and cooling promptly and can shorten the heating time required to rise the temperature of the mold 10 to the glass transition temperature and the cooling time required to fall temperature from the glass transition temperature. Consequently, the work speed in recoating the coating formed portion of the optical fiber can be improved much more.

In the embodiment of the invention, the connecting part, which is the coating formed portion of the optical fiber, was recoated as mold temperatures are varied. In this example, the UV resin was used as the light-curing resin. The UV resin 7 used is most efficiently cured at the glass transition temperature or at a heat setting temperature of about 80° C. in the ultraviolet light irradiation energy of 3000 mJ/cm².

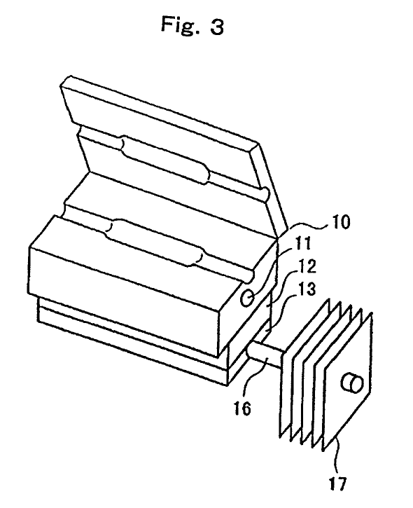

One example of the recoating process will be described in reference with FIG. 2 that illustrates the time variation in mold temperatures. The process is as follows. That is:

1) First, in order to improve the flowability of the UV resin 7, the Peltier element 12 and the heater 13 raise the temperature of the mold 10 from room temperature (20° C. in this case) to about 25° C.

Time t₁ is the heating start time of the mold 10 from room temperature and time t₂ is the time at which the mold temperature reaches about 25° C.

2) The mold temperature is held at about 25° C. from time t₂ to t₃, during which, the UV resin 7 is filled in the mold 10. At this temperature (about 25° C.), the UV resin 7 has excellent flowability and is filled in the mold 10 easily. Therefore, the light-curing resin can flow inside the mold smoothly and is filled sufficiently. Bubbles can be prevented from being generated.

3) Then, the mold 10 is heated from about 25° C. to the glass transition temperature (about 80° C. in this case), and this temperature is held for a fixed period of time.

Time t₄ is the time at which the mold temperature reaches the glass transition temperature and time t₅ is the period of time to hold at the glass transition temperature.

During this period of time (from time t₃ to time t₆), the ultraviolet light irradiates the UV resin 7 to cure the UV resin 7.

4) Subsequently, the Peltier element 12 and the fan 14 cool the mold 10 from the glass transition temperature to about 25° C. After that, the optical fiber connecting part is removed from the mold 10 to move it to the subsequent process.

Time t₆ is the time at which the mold temperature reaches about 25° C. In this recoating process, the time required for recoating is t₆-t₁.

In the recoating process, the ultraviolet light irradiates the UV resin 7 with the UV resin 7 held at the glass transition temperature, using heat setting and light-curing at the same time. Thus, the time required to cure the UV resin 7 (t₅-t₃) can be shortened as compared with the time to irradiate the ultraviolet light at ordinary temperature for curing.

In addition, the use of the Peltier element 12 as the heating-and-cooling unit shortens the heating time (t₄- t₃) required to raise the temperature of the mold 10 (in other words, the UV resin 7) and the cooling time (t₆-t₅) required to fall temperature. Thus, the recoating time can be curtailed.

When the time required for the coating forming process of the optical fiber in the embodiment (t₆-t₂) is compared with the time required for the coating forming process of the orthodox method (for example, as indicated by a dotted line in FIG. 2, the ultraviolet light irradiates the UV resin 7 as the mold temperature is held at 25° C.), the coating forming time could be shortened about 40% in the embodiment.

Furthermore, the heating-and-cooling unit for the mold 10 is not limited to the above-described embodiment. For example, as shown in FIG. 3, a heat pipe 16 with fins 17 may be used as a cooling unit.

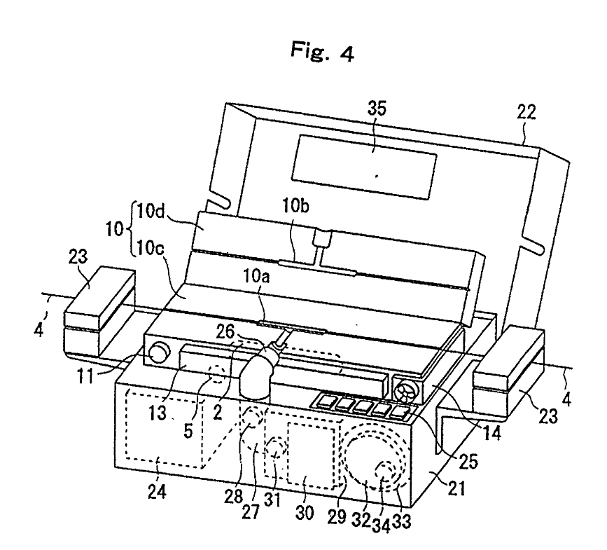

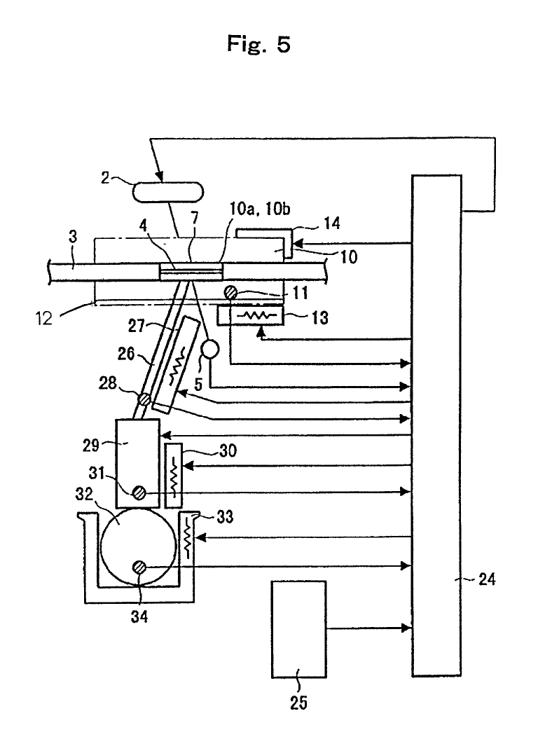

FIG. 4 depicts the perspective diagram of the other embodiment of the coating forming apparatus for the optical fiber in the invention and FIG. 5 depicts the illustration thereof. In addition, in the embodiment shown in FIGS. 4 and 5, a UV resin having the glass transition temperature or the heat setting temperature of 40° C. was used.

In the embodiment shown in FIG. 4, a mold 10 is housed inside an apparatus main body 21 equipped with a lid 22. The mold 10 comprises an upper mold 10d and an under mold 10c. The upper mold 10d is provided with a groove part 10b for forming a resin mold and the under mold 10c is provided with a groove part 10a for forming the resin mold. Additionally, clamps 23 for holding an optical fiber 4 are mounted on both sides of the apparatus main body 21. A numeral 24 denotes a controller having a microcomputer that stores a program and a numeral 25 denotes an operating panel.

In this embodiment, a heater 27 and a temperature sensor 28 are mounted on a tube 26 for injecting the UV resin into the upper mold 10d and the under mold 10c. Furthermore, a heater 30 and a temperature sensor 31 are mounted on a pump 29 for injecting the UV resin into the under mold 10c. Moreover, a heater 33 and a temperature sensor 34 are mounted on a tank 32 for storing the UV resin to be injected into the upper mold 10d and the under mold 10c.

As shown in FIG. 5, a controller 24 adjusts the temperatures of the mold 10, the tube 26, the pump 29 and the tank 32 by a fan 14, heaters 13, 27, 30 and 33 based on the outputs of temperature sensors 11, 28, 31 and 34. Besides, the controller 24 adjusts the quantity of light of a light source 2 based on the output of a photodetector 5. In the example shown in FIG. 4, the light source 2 is set under the under mold 10c that is made of a glass plate (made of quarts glass having a high melting point or vitrified ceramic), for irradiating the UV resin with the ultraviolet light through the under mold 10c.

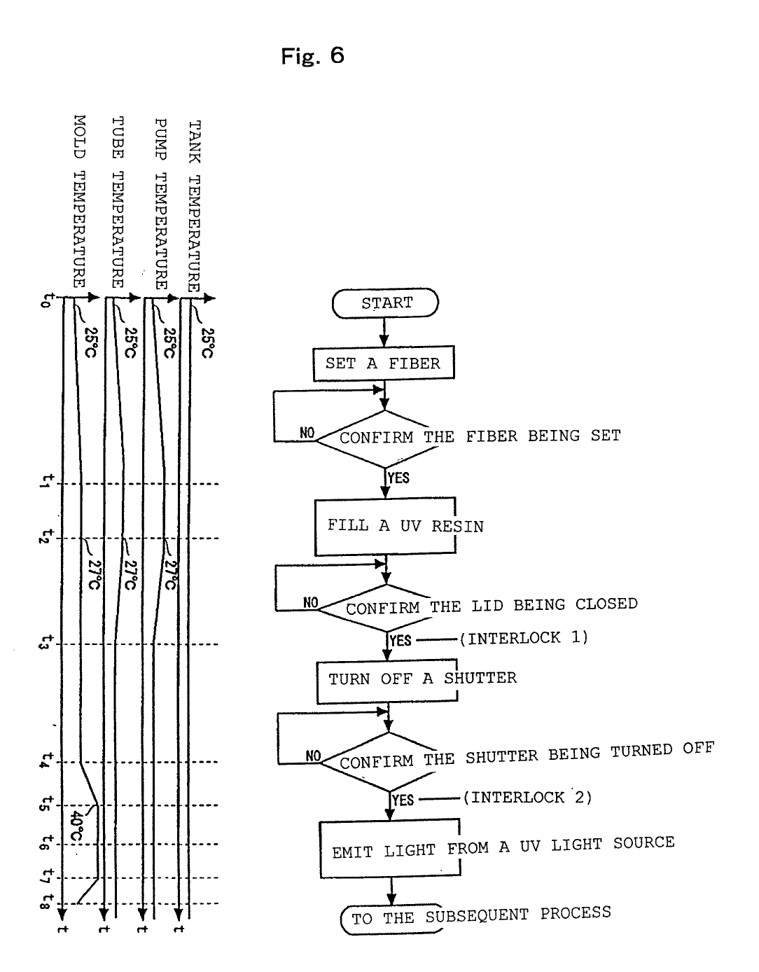

Next, with reference to FIG. 6, the operation of the coating forming apparatus of the embodiment will be described. Additionally, in the embodiment shown in FIG. 6, a UV resin having the glass transition temperature or the heat setting temperature of 40° C. was used. The operating procedure is as follows. That is:

1) Each of the temperatures of the mold 10, the tube 26, the pump 29 and the tank 32 are set to 25° C. and an optical fiber 4 is set in the mold 10 (time t₀).

Then, the temperatures of the mold 10, the tube 26 and the pump 29 are raised from 25° C. to 27° C. (time t₀ to t₁).

2) The operating panel 25 is manipulated to work the pump 29 and a proper amount of the UV resin is delivered from the tank 32 to the tube 26 to fill it in the groove part 10b (time t₁ to t₂). At this time, the UV resin is heated at 27° C. and has excellent flowability, which is filled in the groove part 10b smoothly.

3) The lid 22 is closed and the temperatures of the tube 26 and the pump 29 are fallen to 25° C. as the temperature of the mold 10 is maintained at 27° C. (time t₂ to t₃). Additionally, interlocking with the lid 22 being closed, a first switch (not shown) of the light source 2 is turned on (Interlock 1).

4) An electronic (liquid crystal or the like) shutter 35 disposed at the window of the lid 22 is turned off (in the case of using a mechanical shutter, it is closed) (time t₃ to t₄). The shutter 35 is turned off and thereby a second switch (not shown) of the light source 2 is turned on, interlocking with that (Interlock 1). Then, by manipulating the operating panel 25, the UV light is irradiated from the light source 2.

In addition, the shutter 35 is disposed at the window of the lid 22 for confirming the conditions of the coated optical fiber 4 being set to the groove parts 10a and 10b of the mold 10 or the conditions of the UV resin being filled inside the mold 10 (a filling manner), with the lid 22 closed. Then, by turning off the shutter 35, outside light is prevented from being entered from the lid 22 and the UV light from the light source 2 is prevented from radiating outside.

5) The temperature of the mold 10 is raised to 40° C. of the heat setting temperature (time t₄ to t₅) to maintain this temperature (time t₅ to t₆ to t₇).

6) Thereafter, the temperature of the mold 10 is fallen to 25° C. (time t₇ to t₈). When the temperature is fallen to 25° C. (time t₈), the lid 22 is opened to remove the coated optical fiber 4 out of the mold 10.

In this embodiment, the temperatures of the mold 10, the tube 26, the pump 29 and the tank 32 can be controlled properly. Therefore, the UV resin is allowed to flow inside the mold 10 smoothly with the flowability enhanced (improved), the resin can be filled therein smoothly and surely, and bubbles can be prevented from being generated.

What is claimed is:

1. A method of forming a coating on an optical fiber comprising the steps of:
providing a light-curing resin on a coating forming portion of an optical fiber; and
irradiating with a light for curing the light-curing resin which has been heated up to a glass transition temperature of the resin or other heat setting temperatures.

2. The method of forming a coating on the optical fiber according to claim 1,
wherein in heating the light-curing resin, a heating preset temperature is maintained for a predetermined set period of time after having reached the glass transition temperature or the other heat setting temperatures that is a predetermined preset temperature set by a temperature of the light-curing resin due to a temperature rise caused by heating, and
in irradiating the light for curing, irradiation is continuously conducted from a start time of heating for temperature rise toward said heating preset temperature to the end of said set period of time to maintain the heating preset temperature.

3. The method of forming a coating on the optical fiber according to claim 1 comprising setting the coating forming portion of the optical fiber inside a mold, and filling the light-curing resin in the mold to provide the light-curing resin on the coating forming portion of the optical fiber, wherein said mold is heated to a temperature for enhancing flowability of the light-curing resin when the light-curing resin is filled in the mold.

4. A apparatus for forming a coating on an optical fiber comprising:
a mold for coating with a light-curing resin a portion on which a coating is to be formed of an optical fiber;
a heating-and-cooling unit for selectively heating and cooling the light-curing resin inside said mold;
a temperature sensor for detecting the temperature of said light-curing resin;
a light source for irradiating said light-curing resin with a light for curing; and
a temperature control unit for controlling said heating-and-cooling unit by a temperature detecting output of said temperature sensor to control temperatures of said light-curing resin,
wherein said temperature control unit heat-controls said light-curing resin to a glass transition temperature or other heat setting temperatures when irradiating said light-curing resin with the light for curing and cool-controls said light-curing resin after stopping light irradiating.

5. The apparatus for forming the coating on the optical fiber according to claim 4, wherein a Peltier element is used as the heating-and-cooling unit.

6. The apparatus for forming a coating on the optical fiber according to claim 5, wherein the heating-and-cooling unit includes a heater for heating and an additional unit for cooling in addition to the Peltier element.

7. The apparatus for forming a coating on the optical fiber according to claim 6, wherein the additional unit for cooling comprises a fan or a heat pipe.

8. The apparatus for forming a coating on the optical fiber according to claim 4 further comprising:
a tank for storing the light-curing resin to be injected into the mold;
a tube and a pump for injecting the light-curing resin from said tank to said mold,
wherein each of said tube, pump and tank is provided with a heater and a temperature sensor, and
the temperature control unit controls the heaters of said tube, pump and tank in accordance with a temperature detecting output of each of said corresponding temperature sensors for enhancing flowability of the light-curing resin to be injected into the mold.
